(19) United States
(12) Patent Application Publication
(10) Pub. No.: US 2006/0150544 A1
(43) Pub. Date: Jul. 13, 2006

(54) Interchangeable cutout panels for decorative shutters

(76) Inventors: Daniel N. Foster, Kingsport, TN (US); Meg Ann Foster, Kingsport, TN (US)

Correspondence Address: ARTHUR G. YEAGER, P.A., 245-1 EAST ADAMS STREET, JACKSONVILLE, FL, 32202-3336, US

(21) Appl. No.: 11/018,907

(22) Filed: Dec. 21, 2004

(51) Int. Cl. E06B 1/04

(52) U.S. Cl. 52/204.1

(57) ABSTRACT

An interchangeable panel for a decorative shutter has a frame with front and rear sides and a predetermined sized opening therethrough and a pair of spaced sides and an upper portion and a lower portion. The panel is a planar member adapted to be removably attached to a shutter using a pair of cooperating fasteners attachable to the front of the shutter and to the rear side of the panel. In addition, three types of channels may be formed in the shutter frame for carrying the panel therein.

### CROSS REFERENCE TO RELATED APPLICATION

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates to decorative shutters employing interchangeable cutouts and particularly to cutouts for either newly constructed shutters during manufacture or for retrofitting existing shutters.

2. Relevant Art

The prior art provides a wide variety of removable panels and replaceable panel inserts. However, louvered shutters do not provide for cutout designs for at least three reasons.

First, the appearance of the cutout would be severely distorted. Due to the fact that it is necessary to cut through several louver blades with each blade positioned at an angle from horizontal, the edges of the image created by the cutout would be irregular in appearance. A flat panel is needed to create a cutout that is clearly recognizable (with clearly defined edges). Second, on a functional louvered shutter, the louver blades are connected to a tilt rod that is typically attached to the center of the blades on the backside of the shutter. To create a cutout design, it would be necessary to remove a portion of the tilt rod, thereby rendering the shutter non-functional. Also, each louver blade is held in place by a pivoting attachment at both ends of the blade. To cut out a portion of the blade would be to remove one of these points of attachment, also rendering the shutter non-functional. Third, a functional shutter is designed to open and close thereby allowing varying degrees of light or wind/air to pass through. By leaving a permanent hole in the shutter, a cutout would impair this function.

### BRIEF SUMMARY OF THE INVENTION

In one aspect of the present invention, there is provided an interchangeable panel for a decorative shutter having a frame with front and rear sides and a predetermined sized opening therethrough, a pair of spaced sides and an upper portion and a lower portion, the panel comprising a planar member having front and rear faces and having upper and lower edges, the panel is adapted to be removably attached to a shutter, and attachment means removably securing the panel in its location covering a predetermined sized opening of a frame of a shutter. The attachment means includes a pair of cooperating fastener means, one fastener means attachable to the front side of a shutter and another fastener means attachable to the rear side of the panel for removably securing the panel to a front side of a shutter. One fastener means includes a plurality of spaced magnetic members and another fastener means includes a plurality of spaced metal plate members. The one fastener means includes a first pair of spaced magnetic members attachable to an upper portion of a front side of a shutter and a second pair of spaced magnetic members attachable to the upper portion of a shutter and disposable below the first pair of magnetic members, the another fastener means includes a first pair of spaced metal members attachable to the upper portion of the rear side of the panel and a second pair of spaced members attachable to the lower portion of the rear side of the panel. Alternately, one fastener means includes a metal frame member attachable to the front side of a shutter, and another fastener means includes a pair of spaced magnetic strip elements attachable to the rear side of the panel and locatable to contact the metal frame for removably securing the panel to a front side of a shutter. The attachment means may include double-sided tape on the rear side of the panel for attaching the panel to a portion of a shutter. The double-sided tape can be used to attach the magnets on metal plates to the front of the shutter and/or the back of the panel. The attachment means may include interlocking fasteners attachable to the panel and attachable to a front side of a shutter for removably attaching the panel to a shutter.

In another aspect of the invention, there is provided an interchangeable panel for a decorative shutter comprising a frame having front and rear sides and an opening of predetermined size therethrough and spaced side edges, said panel including at least one planar member having upper and lower edge portions and spaced side portions, the panel sized to removably attach to the frame. A channel is formed within the frame between the front and rear sides having upper and lower walls with an opening at one side edge of the frame and terminating in a vertical wall spaced away from the other side edge. The panel is sized to fit in the channel, the upper edge portion of the panel being disposable closely adjacent the upper wall of the channel and the lower edge portion of the panel being disposable closely adjacent the lower wall of the channel. The panel is sized to fit in the channel, one portion of the panel being positionable closely adjacent the one side edge of the frame and another edge portion of the panel being positionable closely adjacent the other side edge of the frame. The frame includes a notch formed in the rear side adjacent the opening of the channel to allow a user to grasp the panel. The panel includes a fingerhole formed adjacent one side portion of the panel alignable with the notch in the frame for allowing a user to remove the panel from the frame of the shutter. The channel may be formed within the frame between the front and rear sides and having upper and lower walls extending from the one side edge of the frame through the other side edge, the panel being removably disposable within the channel. Alternately, the channel is formed within the front side of the frame between the side edges, the panel being removably disposable within the channel.

In another aspect of the invention, there is provided a method for interchanging panels used in decorative shutters having front and rear sides comprising the steps of: forming an opening of a predetermined size in the shutter; providing a panel having front and rear sides of sufficient size to cover the opening formed; and removably attaching the panel to the shutter over the opening formed. Additional steps may include forming a recessed channel in the shutter around the opening and inserting the panel into the channel formed. First and second pairs of cooperating fasteners may be used in affixing a first pair of spaced fasteners to the rear side of the panel; affixing a second pair of spaced fasteners to the front side of the shutter at locations respectively aligned with the first pair of fasteners attached to the panel. A recessed channel may be formed between the front and sides of the shutter around the opening; inserting the panel in the channel; providing a cross-member extending between two vertical members forming the frame of the shutter; and attaching the cross-member to a louver generally medially of the shutter located between the two vertical members.

### BRIEF DESCRIPTION OF THE SEVERAL VIEWS OF THE DRAWING

The novel features which are believed to be characteristic of this invention are set forth with particularity in the appended claims. The invention itself, however, both as to its organization and method of operation, together with further objects and advantages thereof, may best be understood by reference to the following description taken in connection with the accompanying drawings, in which:

FIG. 1 is a front view of a raised panel shutter with an interchangeable cutout panel in accord with the present invention;

FIG. 2 is a side view of the shutter of FIG. 1;

FIG. 3 is a top view of the shutter of FIGS. 1 and 2;

FIG. 4 is a front view of a recessed panel shutter with an interchangeable cutout panel in accord with the present invention;

FIG. 5 is a side view of the shutter of FIG. 4;

FIG. 6 is a top view of the shutter of FIGS. 4 and 5;

FIG. 7 is a front view of a louvered shutter with an interchangeable cutout panel in accord with the present invention;

FIG. 8 is a side view of the shutter of FIG. 7;

FIG. 9 is a top view of the shutter of FIGS. 7 and 8;

FIG. 10 is a front view of a board and batten shutter with an interchangeable cutout panel in accord with the present invention;

FIG. 11 is a side view of the shutter of FIG. 10;

FIG. 12 is a top view of the shutter of FIGS. 10 and 11;

FIG. 13 is a front view of a cross-member used in retrofitting an interchangeable cutout panel in accord with the present invention to a louvered shutter;

FIG. 14 is a side view of the cross-member of FIG. 13;

FIG. 15 is a top view of the cross-member of FIGS. 13 and 14;

FIG. 16 is a side view of another cross-member used in retrofitting an interchangeable cutout panel in accord with the present invention to a louvered shutter;

FIG. 17 is a side view of the cross-member of FIG. 16;

FIG. 18 is a top view of the cross-member of FIGS. 16 and 17;

FIG. 19 is a front view of a louvered shutter illustrating the addition of an interchangeable cutout panel in accord with the present invention;

FIG. 20 is a front view of another louvered shutter illustrating the attachment of an interchangeable cutout panel fastener to the shutter;

FIG. 21 is a front view of the shutter of FIG. 20 illustrating the addition of an interchangeable cutout panel to the panel fastener;

FIG. 22 is a front view of a shutter illustrating the installation of an interchangeable cutout panel to the shutter;

FIG. 23 is a front view of a louvered shutter with holes drilled in a louver;

FIG. 24 is a detail of a nylon push-type fastener attached to a cross-member;

FIG. 25 is a detail of double-sided tape attached to a cross-member;

FIG. 26 is a front view of a louvered shutter having panel-mounting magnets attached thereto;

FIG. 27 is a front view of the shutter of FIG. 26 showing a metal panel-mounting frame attached thereto;

FIG. 28 is a rear view of a panel illustrating alternate means for attachment to the frame in FIG. 27;

FIG. 29 is a rear view of a panel showing alternative fasteners;

FIG. 30 is a side view detail of an alternate fastener on a cross-member;

FIG. 31 is an alternate to the device of FIG. 24; and

FIG. 32 is an alternate to the arrangement of FIG. 25.

### DETAILED DESCRIPTION OF THE INVENTION INTRODUCTION

The present invention involves mounting cutout panels to decorative panel shutters and louvered shutters. The mounting is provided for new construction and for retrofitting to existing shutters.

One method to construct a new shutter that incorporates cutout panels would involve a recessed channel (slot, groove) formed into the frame members of the shutter that immediately surround the sides of the cutout panel. The cutout panel would be placed into this channel. The channel is cut to a slightly greater width than the panel-providing a tight enough fit to hold the panel in place, yet allow the panel to easily slide in or out of the shutter frame. This channel passes through the entire width of the side frame member that is located on the open side of the shutter (the other side of the shutter being adjacent to the window). A small semicircular notch is removed from the rear surface of the side frame member. Cutout panels have a small notch or hole in their construction aligned with the location of this semicircular notch. To remove the cutout panel, one would simply reach into this notch, hook a finger into the panel and slide the panel out. On a board and batten shutter, the channels are cut, machined, or molded into the two cross-members that are located immediately above and below the cutout panel. Constructing a shutter in this manner eliminates the need for fasteners because the frame of the shutter holds the cutout panel in place. Such construction would also give the shutter an “original” appearance when viewed from the front because the means of attachment for the cutout panels would not be noticeable.

To convert an existing louvered shutter into a combination shutter that would incorporate interchangeable cutout panels, a cross-member or “trim piece” is added to the shutter. This cross-member serves as the divider between the louvered portion of the shutter and the portion of the shutter that would incorporate the interchangeable cutout panels. One method to attach this cross-member to the shutter would be to use nylon push-type fasteners. These fasteners would be fixed to the back of the cross-member. Holes to receive these fasteners would be drilled into the desired louver blade. The cross-member would then be pushed or pressed into its permanent position on the shutter. A second method to attach this cross-member to the shutter would be to fix U-clips to the back of the cross-member. These U-clips would be sized to clip on to the louver blade at the desired point of location. A third method to attach this cross-member to the shutter would be to use double-sided tape. The tape would be attached to the back of the cross-member. To fix the cross-member to the shutter, one would remove the protective strip from the remaining side of the tape, and press the cross-member to the desired louver blade. The tape would thereby bind the cross-member to the louver blade. In addition, “snap-on” type cross-members may be used as will be discussed hereinbelow with respect to FIG. 13. In any case, the fasteners are hidden by the cross-member. Thus the shutter looks as though it had been originally constructed with the cross-member (and cutout panel) in place.

The cutout panels can also be held in place by the use of 37 removable” fasteners that are fixed to the back of the panel and the shutter or shutter frame. One method would be to use magnets and non-corrosive sheet metal plates. The magnets would be fixed to the shutter or shutter frame and the metal plates to adjacent positions on the back of the cutout panels in place. If necessary, a sheet metal frame could be fixed to the shutter and magnetic tape attached to the cutout panel. This would allow the entire perimeter of the panel to attach to the shutter. In either case the space between the cutout panel and the shutter is minimal and the fasteners are hidden by the panel.

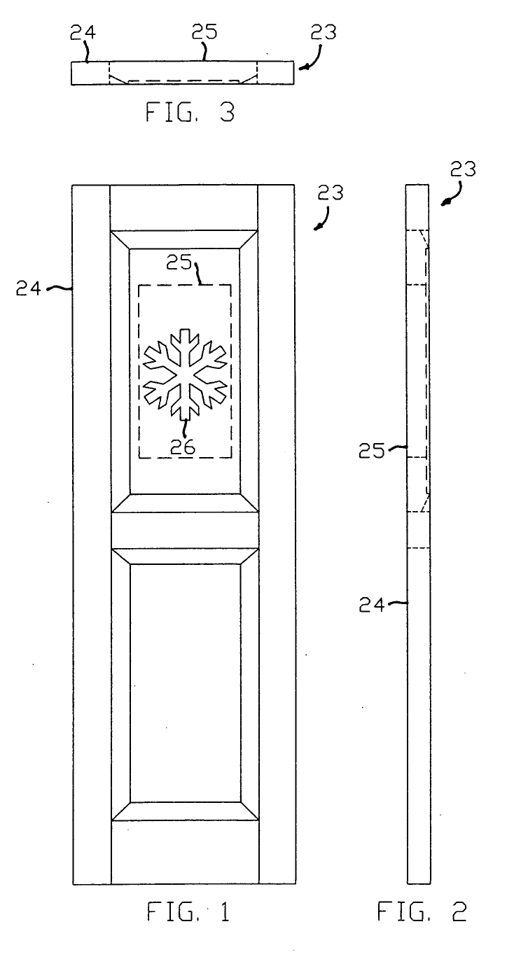

With respect now to the drawings, a conventional raised panel shutter is shown at 23 in FIGS. 1-3. Frame 24 includes a cutout panel 25 having cutout portion 26. This shutter represents new construction. The cutout panel 25 can be attached to shutter 23 by any appropriate means as will be discussed hereinbelow.

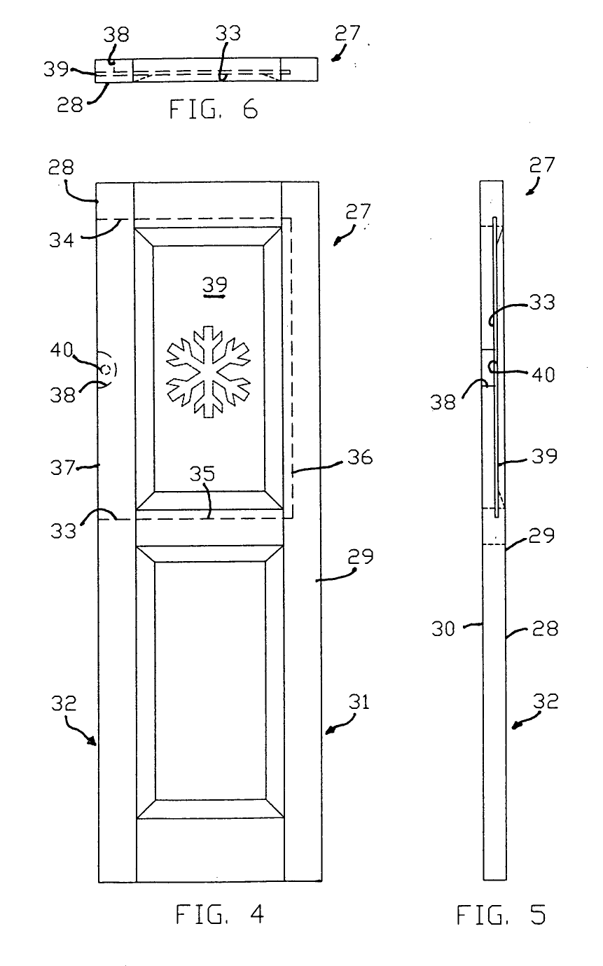

FIGS. 4-6 illustrate the new construction of a recessed panel shutter 27 having a frame 28 with a front portion 29 and rear portion 30 and first and second sides 31, 32. A channel or slot 33 in frame 28 includes upper and lower wall portions 34, 35 and a closed far side portion 36 and an open near side portion 37. Near side portion 37 includes a notch 38. Cutout panel 39 includes a finger hole 40, which is inserted in channel 33 from near side 37. A user can grasp the panel 39 and replace it with another as desired.

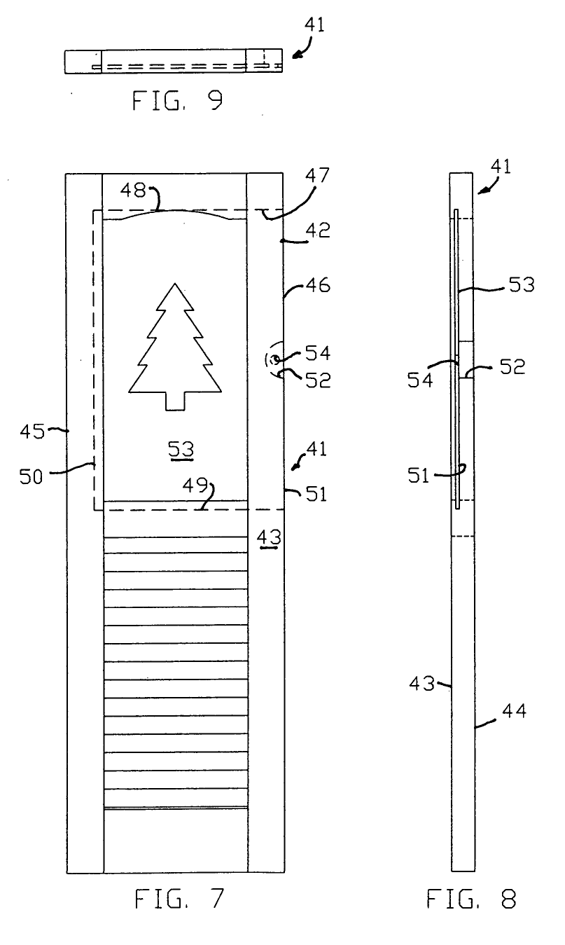

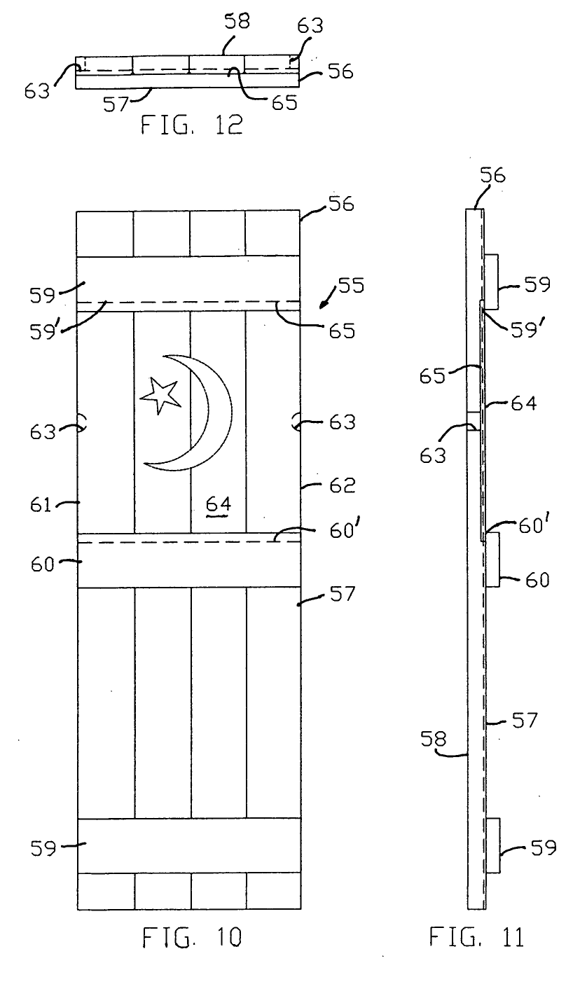

FIGS. 7-9 illustrate a new construction louvered shutter 41. Frame 42 includes front 43, rear 44, and first and second sides 45, 46. A channel or slot 47 has upper wall portion 48, lower wall portion 49 and closed far side portion 50 and an open near side portion 51. A notch 52 is cut into rear side 42. A cutout panel 53 has a finger hole 54 for grasping panel 53 to remove or install it in channel 47.

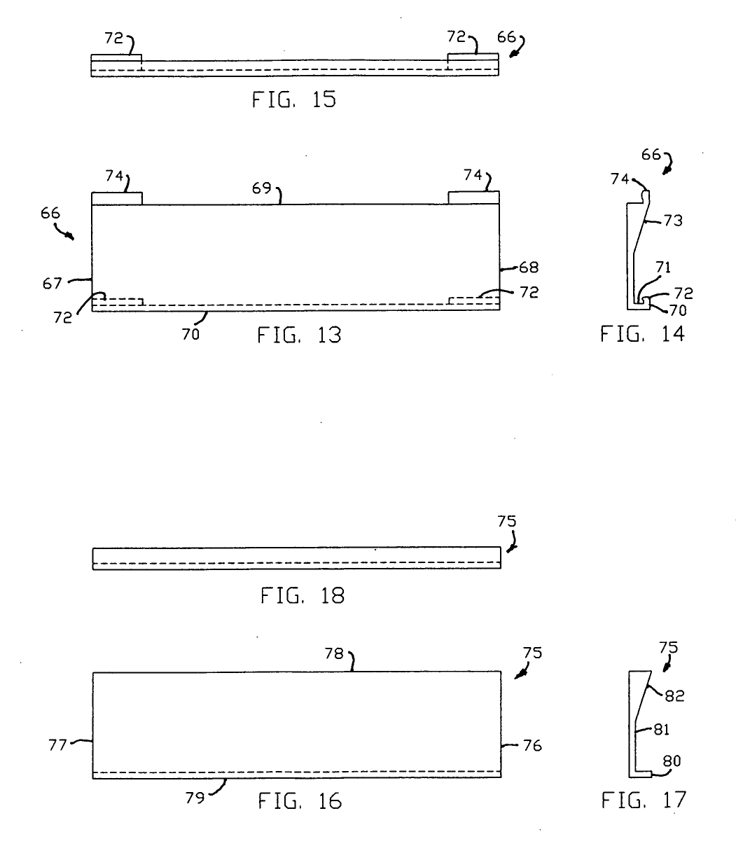

FIGS. 10-12 indicate a new construction board and batten shutter 55 having frame 56 with front and rear 57, 58 and upper and lower cross-members 59 and a middle cross-member 60. A pair of spaced notches 63 are formed in respective near and far sides 61, 62 of front 57 of frame 56. A cutout panel 64 is placed in channel 65 open at both ends between upper and lower walls 59′, 60′. Panel 64 is secured in place by the overlap of the channel 65 by a lower portion of upper cross-member 59 and an upper portion of middle cross-member 60 as clearly shown in FIG. 11.

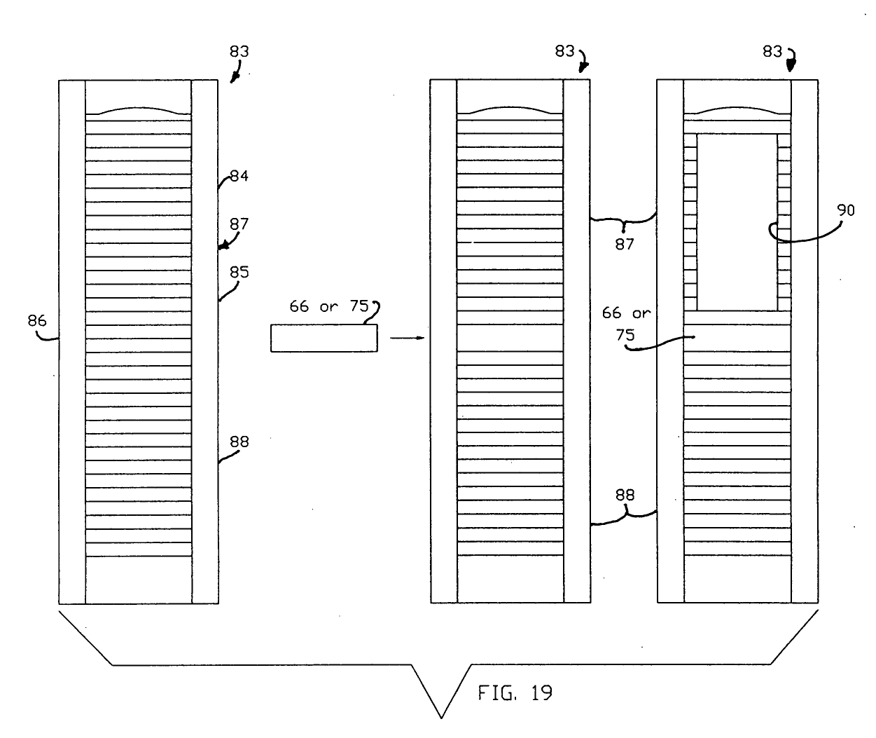

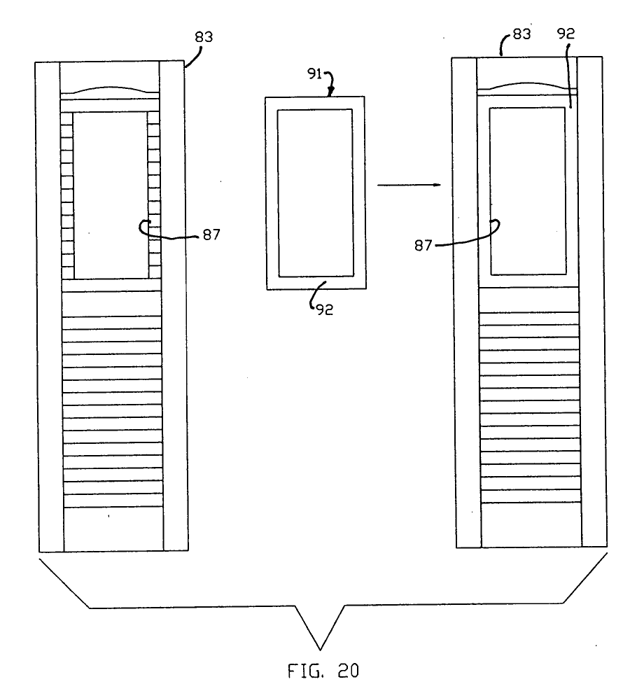

FIGS. 13-15 illustrate one type of cross-member 66 used for a snap-on fit attachment to a louvered shutter. The member 66 includes spaced ends 67 and 68 and upper and lower side portions 69, 70. Upstanding spaced wall portions 72 have a lower channel 71 and a tapered upper portion 73 includes an upper upstanding wall 74. Member 66 snaps into place by inserting walls 72, 74 in between spaced louver blades.

FIGS. 16-18 illustrate a second type of cross-member 75 having spaced ends 76, 77 and upper and lower portions 78, 79. As shown clearly in FIG. 17, a lower ledge portion 80 fits between two louver blades. Upstanding wall portion 81 includes a tapered upper portion 82 that matches the downwardly inclined disposition of a louver blade. The cross-member 75 is attached to a shutter as will be discussed hereinbelow.

FIG. 19 illustrates the first steps in the retrofitting of a standard louvered shutter 83 having a frame 84, opposite side members 85, 86, and divided into upper and lower portions 87, 88. A cross-member 66 or 75 is installed over two louvers by appropriate means. A window 90 is cut out of the upper portion 87.

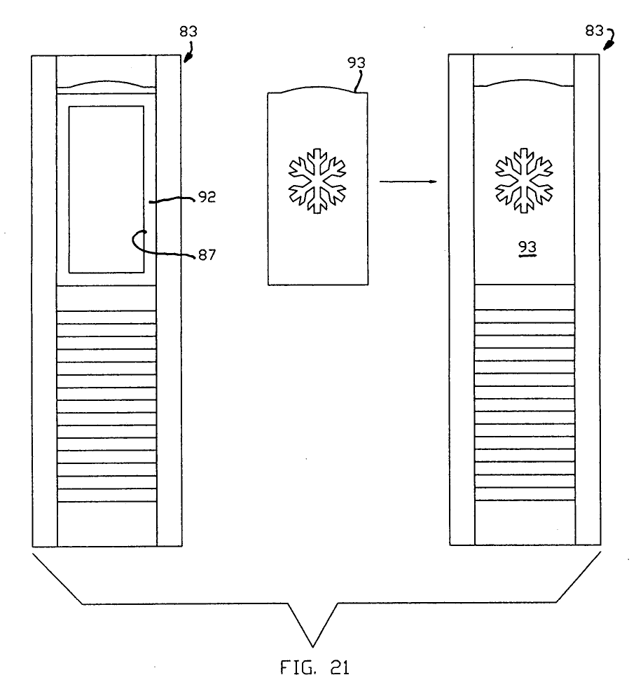

Further steps of retrofitting the shutter 83 includes the attachment means 91 in the form of a frame 92 that is itself fastened around window 87 as illustrated. In FIG. 21, a cutout panel 93 is fastened to the frame 92.

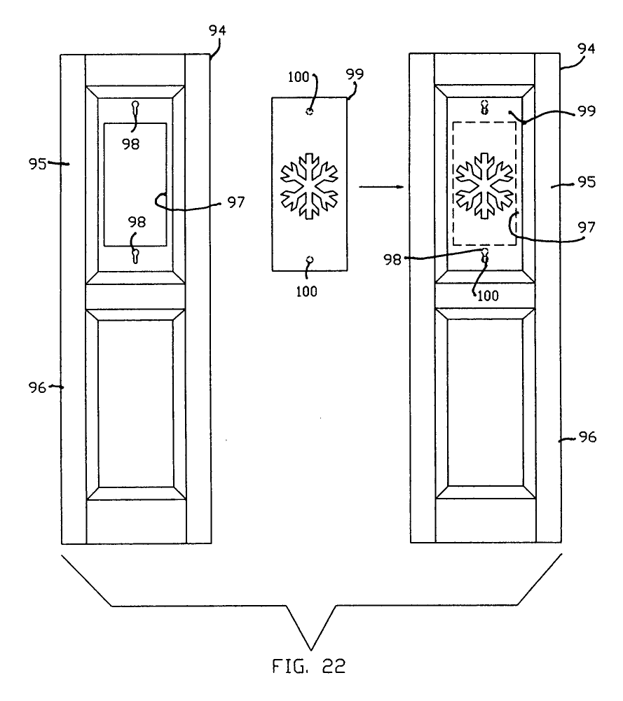

In FIG. 22, the retrofitting of an existing raised panel shutter 94 having an upper and lower portion 95, 96. A section 97 of the upper portion 95 is cutout and a pair of vertically spaced keyholes 98 is drilled in the upper portion 95. A cutout panel 99 has prongs 100 extending rearwardly and inserted in the keyholes 98 to mount the panel 99 onto panel 94 as shown.

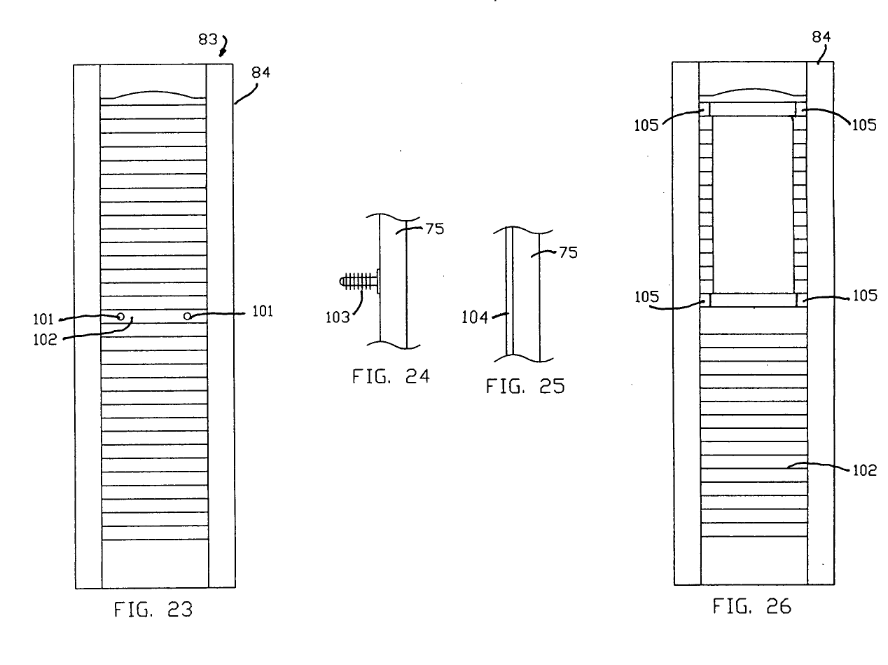

FIGS. 23-28 illustrate various attachment means employed in the present invention. In FIGS. 23 and 24, a pair of spaced holes 101 in a shutter member 102 into which fit laterally extending prong elements in the form of a pair of spaced nylon push-type fasteners 103 screwed into cross-member 75. In an alternate method, double-sided tape 104 (FIG. 25) is secured to a cross member 75.

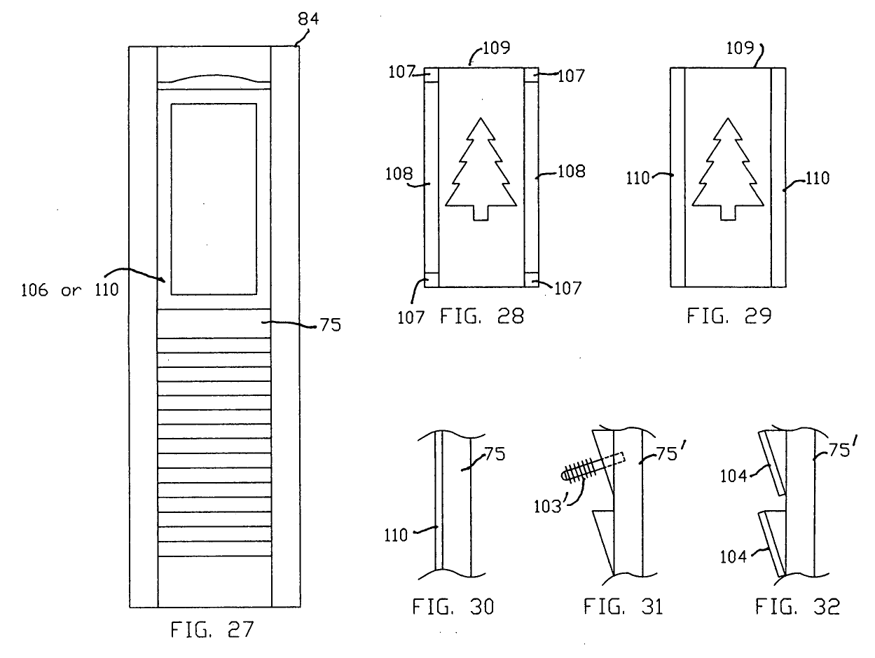

In FIG. 26, four spaced magnets 105 are attached to members 102 by adhesive such as double-sided tape 104. A metal frame 106 is then mounted onto the magnets 105 (FIG. 27). If a metal frame 106 is used, it may be secured to either the front of the shutter or the back of the panel. The magnets would be attached to the shutter or panel as appropriate. A cutout panel 109 of any desired pattern, has spaced magnetic strips 108 on the rear side. Alternately, a group of four metal members 107 may be glued to the cutout panel 109 which can adhere to magnets 105 (FIG. 28). Other methods of attaching the various items, including the panels, may include double-sided tape 104, and interlocking fasteners 110 (FIGS. 27, 29, 30).

FIGS. 31 and 32 illustrate the attachment means fastener 103′ used on a cross-member 75′ for attachment to louver blades. The cross-member 75′ has an angled face to conform to the angle of the louver blades to enhance the contact between the fastener means and the louver.

While the invention has been described with respect to certain specific embodiments, it will be appreciated that many modifications and changes may be made by those skilled in the art without departing from the spirit of the invention. It is intended therefore, by the appended claims to cover all such modifications and changes as fall within the true spirit and scope of the invention.

What is claimed as new and what it is desired to secure by Letters Patent of the United States is:

1. An interchangeable panel for a decorative shutter having a frame with front and rear: sides and a predetermined sized opening therethrough, a pair of spaced sides and an upper portion and a lower portion, said panel comprising a planar member having front and rear faces and having upper and lower edges, said panel being adapted to be removably attached to a shutter, and attachment means removably securing said panel in its location covering a predetermined sized opening of a frame of a shutter.

2. The panel as defined in claim 1 wherein said attachment means includes a pair of cooperating fastener means, one said fastener means attachable to the front side of a shutter and another said fastener means attachable to said rear side of said panel for removably securing said panel to a front side of a shutter.

3. The panel as defined in claim 2 wherein one said fastener means including a plurality of spaced magnetic members and another said fastener means includes a plurality of spaced metal plate members.

4. The panel as defined in claim 3 wherein one said fastener means includes a first pair of spaced magnetic members attachable to an upper portion of a front side of a shutter and a second pair of spaced magnetic members attachable to the upper portion of a shutter and disposable below said first pair of magnetic members, said another fastener means includes a first pair of spaced metal members attachable to said upper portion of said rear side of said panel and a second pair of spaced members attachable to said lower portion of said rear side of said panel.

5. The panel as defined in claim 2 wherein said one fastener means includes a metal frame member attachable to the front side of a shutter, and said another fastener means includes a pair of spaced magnetic strip elements attachable to said rear side of said panel and locatable to contact said metal frame for removably securing said panel to a front side of a shutter.

6. The panel as defined in claim 3 wherein said attachment means includes double-sided tape attachable to said magnetic members for mounting said magnetic members to a shutter.

7. The panel as defined in claim 1 wherein said attachment means includes interlocking fasteners attachable to said panel and attachable to a front side of a shutter for removably attaching said panel to a shutter.

8. An interchangeable panel for a decorative shutter comprising a frame having front and rear sides and an opening of predetermined size therethrough and spaced side edges, said panel including at least one planar member having upper and lower edge portions and spaced side portions, said panel sized to removably attach to said frame.

9. The interchangeable panel as defined in claim 8 further including a channel formed within said frame between said front and rear sides having upper and lower walls with an opening at one said side edge of said frame and terminating in a vertical wall spaced away from said other side edge.

10. The panel as defined in claim 9 wherein said at least one cutout panel is sized to fit in said channel, said upper edge portion of said panel being disposable closely adjacent said upper wall of said channel and said lower edge portion of said panel being disposable closely adjacent said lower wall of said channel.

11. The panel as defined in claim 9 wherein said panel is sized to fit in said channel, one said portion of said panel being positionable closely adjacent said one side edge of said frame and another said edge portion of said panel being positionable closely adjacent said other side edge of the frame.

12. The panel as defined in claim 9 wherein said frame includes a notch formed in said rear side adjacent said opening of the channel to allow a user to grasp said panel.

13. The panel as defined in claim 12 wherein said panel includes a fingerhole formed adjacent one said side portion of said panel alignable with said notch in said frame for allowing a user to remove said panel from said frame of said shutter.

14. The panel as defined in claim 8 further including a channel formed within said frame between said front and rear sides and having upper and lower walls extending from said one side edge of said frame through said other side edge, said panel being removably disposable within said channel.

15. The panel as defined in claim 8 further including a channel formed within said front side of said frame between said side edges, said panel being removably disposable within said channel.

16. A method for interchanging panels used in decorative shutters having front and rear sides comprising the steps of:
(A) forming an opening of a predetermined size in the shutter;
(B) providing a panel having front and rear sides of sufficient size to cover the opening formed in step A; and
(C) removably attaching the panel to the shutter over the opening formed in step A.

17. The method of claim 16 wherein step C includes the steps of:
(D) forming a recessed channel in the shutter around the opening of step A; and
(E) inserting the panel of step B into the channel formed in step D.

18. The method of claim 16 wherein step C includes the steps of:
(D) providing first and second pairs of cooperating fasteners;
(E) affixing a first pair of spaced fasteners of step D to the rear side of the panel; and
(F) affixing a second pair of spaced fasteners of step D to the front side of the shutter at locations respectively aligned with the first pair of fasteners attached to the panel.

19. The method of claim 16 wherein step C includes the step of:
(D) forming a recessed channel between the front and sides of the shutter around the opening of step A; and
(F) inserting the panel in the channel of step D.

20. The method of claim 16 further including the step of:
(D) providing a cross-member extending between two vertical members forming the frame of the shutter; and
(E) attaching the cross-member to a louver generally medially of the shutter located between the two vertical members.
